(19) United States
(12) Patent Application Publication
(10) Pub. No.: US 2012/0308954 A1
(43) Pub. Date: Dec. 6, 2012

(54) DENTAL MODELS USING STEREOLITHOGRAPHY

(76) Inventor: Patrick C. Dunne, Los Angeles, CA (US)

(21) Appl. No.: 13/575,073

(22) PCT Filed: Feb. 24, 2011
(86) PCT No.: PCT/US11/25981

§ 371 Date: Jul. 25, 2012

Related U.S. Application Data
(60) Provisional application No. 61/307,599, filed on Feb. 24, 2010.

(51) Int. Cl. A61C 11/08; A61C 11/02; G05B 19/18

(52) U.S. Cl. 433/57; 700/98; 433/60

(57) ABSTRACT

A Geller dental arch model includes openings to receive dies. An improvement to the Geller model uses slotted dies, along with complementary support members within the openings of the arch model, to provide proper x, y, and z orientation for the die within the dental model. By avoiding large planar surfaces within the die, this approach can achieve improved fabrication accuracy and better fit for dies and/or arches fabricated with computerized fabrication systems, particularly on surfaces where critical z-axis alignment of a die occurs.

### BACKGROUND

Dentists sometimes use a so-called Geller model to prepare restorations such as crowns for dental patients. The Geller model generally includes removable dies in an arch model. Each die from a Geller model typically has a horizontal bottom surface from which a placement pin extends for fitting the die into the arch model, which has a corresponding flat, top surface and a hole to receive the pin. While some dentists prefer the Geller model over other conventional, hinged models, the relatively large, horizontal surface at the bottom of each die presents substantial challenges for fabrication techniques such as stereolithography. Despite numerous advantages of stereolithography, the additional handling required for these surfaces in a die of a Geller model can render stereolithography unsuitable as a fabrication process in this context.

There remains a need for a Geller-type model adapted for accurate fabrication using stereolithography or other techniques with similar limitations.

### SUMMARY

A Geller dental arch model includes openings to receive dies. An improvement to the Geller model uses slotted dies, along with complementary support members within the openings of the arch model, to provide proper x, y, and z orientation for the die within the dental model. By avoiding large planar surfaces within the die, this approach can achieve improved fabrication accuracy and better fit for dies and/or arches fabricated with computerized fabrication systems, particularly on surfaces where critical z-axis alignment of a die occurs.

In one aspect, a die for use in a dental model disclosed herein includes a top portion having a surface formed into a shape of dentition for a dental patient, a bottom portion tapered for insertion into an arch model, and a plurality of slots that extend vertically from a transverse plane within the die to a bottom surface of the bottom portion and radially from a common location within the die to a side wall of the bottom portion.

The surface may be formed into the shape of a tooth of the dental patient prior to preparation for a restoration. The surface may be formed into the shape of a tooth of the dental patient after preparation for a restoration. The surface may be formed into the shape desired for a tooth after a restoration. Each one of the plurality of slots may have a bottom opening with beveled edges to increase a capture distance of the plurality of slots by a plurality of support members in an opening of an arch model. The plurality of slots may include three slots.

In another aspect, a method for fabricating a die disclosed herein includes receiving a digital surface representation for a dental arch of a dental patient from a three-dimensional scanner, selecting a tooth in the dental arch for a restoration, and creating a digital model of a die for the restoration, the die including a top portion having a surface formed into a shape of dentition for the dental patient, a bottom portion tapered for insertion into an arch model of the dental arch, and a plurality of slots that extend vertically from a transverse plane within the die to a bottom surface of the bottom portion and radially from a common location within the die to a side wall of the bottom portion, and fabricating the die from the digital model using a computerized fabrication process.

The computerized fabrication process may include a stereolithography process. The surface may be formed into the shape of a tooth of the dental patient prior to preparation for a restoration. The surface may be formed into the shape of a tooth of the dental patient after preparation for a restoration. The surface may be formed into the shape desired for a tooth after a restoration. Each one of the plurality of slots may have a bottom opening with beveled edges to increase a capture distance for the plurality of slots by a plurality of support members in an opening of an arch model. The plurality of slots may include three slots.

In another aspect, a computer program product for creating a digital model of a die disclosed herein includes computer executable code embodied on a non-transitory computer readable medium that, when executing on one or more computing devices, performs the steps of receiving a digital surface representation for a dental arch from a three-dimensional scanner, selecting a tooth in the dental arch for a restoration, and creating the digital model of the die for the restoration, the die including a top portion having a surface formed into a shape of dentition for a dental patient, a bottom portion tapered for insertion into an arch model of the dental arch, and a plurality of slots that extend vertically from a transverse plane within the die to a bottom surface of the bottom portion and radially from a common location within the die to a side wall of the bottom portion.

The computer program product may include computer executable code that performs the step of controlling a computerized fabrication system to fabricate the die from the digital model. The computer program product may include computer executable code to perform the step of creating a stereolithography file to fabricate the die. The surface may be formed into the shape of a tooth of the dental patient prior to preparation for a restoration. The surface may be formed into the shape of a tooth of the dental patient after preparation for a restoration. The surface may be formed into the shape desired for a tooth after a restoration. Each one of the plurality of slots may have a bottom opening with beveled edges to increase a capture distance for the plurality of slots by a plurality of support members in an opening of an arch model. The plurality of slots may include three slots.

In another aspect, a device disclosed herein includes a model of a dental arch of a dental patient and an opening in the model for a die, the opening including an interior wall tapered to receive the die and a plurality of support members extending from the side wall to a common location within the opening.

The device may include an articulating hinge attached to a back surface of the model. The device may include a flat surface on a back of the dental arch for attaching an articulating hinge. The model may extend from a first back end of the dental arch to a second back end of the dental arch, the device further comprising a first flat surface on the first back end and a second flat surface on a second back end, wherein the first flat surface and the second flat surface are substantially coplanar. The model may include an upper arch. The model may include a lower arch. The plurality of support members may include three support members. The device may include a kinematic coupling to provide a bite registration with a second model of an opposing arch. The model and the second model, when aligned by the kinematic coupling, may provide a pair of coplanar mounting surfaces for attaching an articulating hinge.

In another aspect, a method for fabricating a dental model disclosed herein includes receiving a digital surface representation for a dental arch of a dental patient from a three-dimensional scanner, creating a digital model of the dental arch, selecting a tooth in the dental arch for a preparation, creating an opening for the tooth in the digital model, the opening including a side wall tapered to receive a die and a plurality of support members extending from the side wall to a common location within the opening, thereby providing a digital arch model, fabricating a physical model from the digital arch model using a computerized fabrication process.

The method may include aligning the dental arch to an opposing arch according to a bite registration of the dental patient. The method may include forming two coplanar surfaces on a back surface of each of the dental arch and the opposing arch for attachment of an articulating hinge. The aligning may be performed using the physical model. The aligning may be performed in a computer environment using the digital model. The method may include adding a kinematic coupling to the digital model to align the digital model to a second digital model of the opposing arch according to the bite registration. The plurality of support members may include three support members.

In another aspect, a computer program product for creating a digital arch model disclosed herein includes computer executable code embodied in a non-transitory computer readable medium that, when executing on one or more computing devices, performs the steps of receiving a digital surface representation for a dental arch of a dental patient from a three-dimensional scanner, creating a digital model of the dental arch, selecting a tooth in the dental arch for a preparation, and creating an opening for the tooth in the digital model, the opening including a side wall tapered to receive a die and a plurality of support members extending from the side wall to a common location within the opening, thereby providing the digital arch model.

The computer program product may include computer executable code that performs the step of controlling a computerized fabrication system to fabricate a physical model from the digital arch model. The computer program product may include computer executable code that performs the step of aligning the dental arch to an opposing arch according to a bite registration of the dental patient. The computer program product may include computer executable code that performs the step of forming two coplanar surfaces on a back surface of each of the dental arch and the opposing arch for attachment of an articulating hinge. The computer program product may include computer executable code that performs the step of adding a kinematic coupling to the digital model to align the digital model to a second digital model of the opposing arch according to the bite registration. The plurality of support members may include three support members.

### BRIEF DESCRIPTION OF THE FIGURES

The invention and the following detailed description of certain embodiments thereof may be understood by reference to the following figures.

FIG. 1 shows a dental image capture system.

FIG. 2 is a block diagram of a generalized manufacturing process for dental objects.

FIG. 3 shows a milling machine.

FIG. 4 shows a stereo lithography apparatus.

FIG. 5 shows a three-dimensional printer.

FIG. 6 is a high-level flow chart of a dental object fabrication process.

FIG. 7 shows an upper and lower arch of a dental model.

FIG. 8 shows a dental model of an arch.

FIG. 9 shows a top perspective view of a die.

FIG. 10 shows a bottom perspective view of a die.

FIG. 11 shows an upper arch and a lower arch of a dental model in occlusion.

FIG. 12 shows an upper arch and a lower arch of a dental model with an articulating hinge.

FIG. 13 shows a process for fabricating a model and/or die.

### DETAILED DESCRIPTION

Described herein are systems and methods of fabricating dental objects for use in dental articulators based upon three-dimensional digital data captured from an intraoral scan. While the description emphasizes certain scanning technologies and certain combinations of fabrication techniques, it will be understood that additional variations, adaptations, and combinations of the methods and systems below will be apparent to one of ordinary skill in the art, such as fabrication of dental restorations not specifically described, or use of three-dimensional output or fabrication technologies not specifically identified herein, and all such variations, adaptations, and combinations are intended to fall within the scope of this disclosure. Further, while the techniques described herein are particularly useful for fabrication of dental models with insertable dies using stereolithography, it will be understood that the techniques described herein may be more generally applied to any context where it is desired to design and fabricate mechanically registered components without the use of large planar surfaces.

In the following description, the term “image” generally refers to a two-dimensional set of pixels forming a two-dimensional view of a subject within an image plane. The term “image set” generally refers to a set of related two dimensional images that might be resolved into three-dimensional data. The term “point cloud” generally refers to a three-dimensional set of points forming a three-dimensional view of the subject reconstructed from a number of two-dimensional views. In a three-dimensional image capture system, a number of such point clouds may also be registered and combined into an aggregate point cloud constructed from images captured by a moving camera. Thus it will be understood that pixels generally refer to two-dimensional data and points generally refer to three-dimensional data, unless another meaning is specifically indicated or clear from the context.

The terms “three-dimensional surface representation”, “digital surface representation”, “three-dimensional surface map”, and the like, as used herein, are intended to refer to any three-dimensional surface map of an object, such as a point cloud of surface data, a set of two-dimensional polygons, or any other data representing all or some of the surface of an object, as might be obtained through the capture and/or processing of three-dimensional scan data, unless a different meaning is explicitly provided or otherwise clear from the context.

A “three-dimensional representation” may include any of the three-dimensional surface representations described above, as well as volumetric and other representations, unless a different meaning is explicitly provided or otherwise clear from the context.

In general, the terms “render” or “rendering” refer to a two-dimensional visualization of a three-dimensional object, such as for display on a monitor. However, it will be understood that three-dimensional rendering technologies exist, and may be usefully employed with the systems and methods disclosed herein. As such, rendering should be interpreted broadly unless a narrower meaning is explicitly provided or otherwise clear from the context.

The term “dental object”, as used herein, is intended to refer broadly to subject matter specific to dentistry. This may include intraoral structures such as dentition, and more typically human dentition, such as individual teeth, quadrants, full arches, pairs of arches which may be separate or in occlusion of various types, soft tissue, and the like, as well bones and any other supporting or surrounding structures. As used herein, the term “intraoral structures” refers to both natural structures within a mouth as described above and artificial structures such as any of the dental objects described below that might be present in the mouth. Dental objects may include “restorations”, which may be generally understood to include components that restore the structure or function of existing dentition, such as crowns, bridges, veneers, inlays, onlays, amalgams, composites, and various substructures such as copings and the like, as well as temporary restorations for use while a permanent restoration is being fabricated. Dental objects may also include a “prosthesis” that replaces dentition with removable or permanent structures, such as dentures, partial dentures, implants, retained dentures, and the like. Dental objects may also include “appliances” used to correct, align, or otherwise temporarily or permanently adjust dentition, such as removable orthodontic appliances, surgical stents, bruxism appliances, snore guards, indirect bracket placement appliances, and the like. Dental objects may also include “hardware” affixed to dentition for an extended period, such as implant fixtures, implant abutments, orthodontic brackets, and other orthodontic components. Dental objects may also include “interim components” of dental manufacture such as dental models (full and/or partial), wax-ups, investment molds, and the like, as well as trays, bases, dies, and other components employed in the fabrication of restorations, prostheses, and the like. Dental objects may also be categorized as natural dental objects such as the teeth, bone, and other intraoral structures described above or as artificial dental objects such as the restorations, prostheses, appliances, hardware, and interim components of dental manufacture as described above.

Terms such as “digital dental model”, “digital dental impression” and the like, are intended to refer to three-dimensional representations of dental objects that may be used in various aspects of acquisition, analysis, prescription, and manufacture, unless a different meaning is otherwise provided or clear from the context. Terms such as “dental model” or “dental impression” are intended to refer to a physical model, such as a cast, printed, or otherwise fabricated physical instance of a dental object. Unless specified, the term “model”, when used alone, may refer to either or both of a physical model and a digital model.

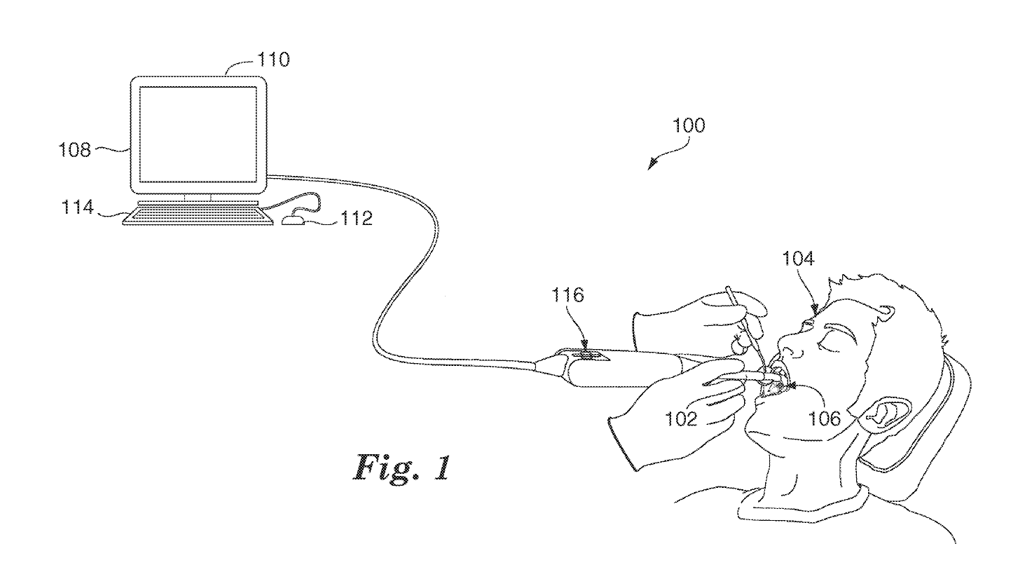

FIG. 1 shows an image capture system. In general, the system 100 may include a scanner 102 that captures images from a surface 106 of a subject 104, such as a dental patient, and forwards the images to a computer 108, which may include a display 110 and one or more user input devices such as a mouse 112 or a keyboard 114. The scanner 102 may also include an input or output device 116 such as a control input (for example, button, touchpad, thumbwheel, etc.) or a display (for example, LCD or LED display) to provide status information.

The scanner 102 may include any camera or camera system suitable for capturing images from which a three-dimensional point cloud may be recovered. For example, the scanner 102 may employ a multi-aperture system as disclosed, for example, in U.S. Pat. No. 7,646,550 to Rohaly, et al. While Rohaly discloses one multi-aperture system, it will be appreciated that any multi-aperture system suitable for reconstructing a three-dimensional point cloud from a number of two-dimensional images may similarly be employed. In one multi-aperture embodiment, the scanner 102 may include a plurality of apertures including a center aperture positioned along a center optical axis of a lens and any associated imaging hardware. The scanner 102 may also, or instead, include a stereoscopic, triscopic or other multi-camera or other configuration in which a number of cameras or optical paths are maintained in fixed relation to one another to obtain two-dimensional images of an object from a number of slightly different perspectives. The scanner 102 may include suitable processing for deriving a three-dimensional point cloud from an image set or a number of image sets, or each two-dimensional image set may be transmitted to an external processor such as contained in the computer 108 described below. In other embodiments, the scanner 102 may employ structured light, laser scanning, direct ranging, or any other technology suitable for acquiring three-dimensional data, or two-dimensional data that can be resolved into three-dimensional data.

In one embodiment, the scanner 102 is a handheld, freely positionable probe having at least one user input device 116, such as a button, lever, dial, thumb wheel, switch, or the like, for user control of the image capture system 100 such as starting and stopping scans. In an embodiment, the scanner 102 may be shaped and sized for dental scanning. More particularly, the scanner may be shaped and sized for intraoral scanning and data capture, such as by insertion into a mouth of an imaging subject and passing over an intraoral surface 106 at a suitable distance to acquire surface data from teeth, gums, and so forth. The scanner 102 may, through such a continuous acquisition process, capture a point cloud of surface data having sufficient spatial resolution and accuracy to prepare dental objects such as prosthetics, hardware, appliances, and the like therefrom, either directly or through a variety of intermediate processing steps. In other embodiments, surface data may be acquired from a dental model such as a dental prosthetic, to ensure proper fitting using a previous scan of corresponding dentition, such as a tooth surface prepared for the prosthetic.

Although not shown in FIG. 1, it will be appreciated that a number of supplemental lighting systems may be usefully employed during image capture. For example, environmental illumination may be enhanced with one or more spotlights illuminating the subject 104 to speed image acquisition and improve depth of field (or spatial resolution depth). The scanner 102 may also, or instead, include a strobe, flash, or other light source to supplement illumination of the subject 104 during image acquisition.

The subject 104 may be any object, collection of objects, portion of an object, or other subject matter. More particularly with respect to the dental fabrication techniques discussed herein, the object 104 may include human dentition captured intraorally from a dental patient's mouth. A scan may capture a three-dimensional representation of some or all of the dentition according to particular purpose of the scan. Thus the scan may capture a digital model of a tooth, a quadrant of teeth, or a full collection of teeth including two opposing arches, as well as soft tissue or any other relevant intraoral structures. In other embodiments where, for example, a completed fabrication is being virtually test fit to a surface preparation, the scan may include a dental prosthesis such as an inlay, a crown, or any other dental prosthesis, dental hardware, dental appliance, or the like. The subject 104 may also, or instead, include a dental model such as a plaster cast, wax-up, impression, or negative impression of a tooth, teeth, soft tissue, or some combination of these.

The computer 108 may be, for example, a personal computer or other processing device. In one embodiment, the computer 108 includes a personal computer with a dual 2.8 GHz Opteron central processing unit, 2 gigabytes of random access memory, a TYAN Thunder K8WE motherboard, and a 250 gigabyte, 10,000 rpm hard drive. This system may be operated to capture approximately 1,500 points per image set in real time using the techniques described herein, and store an aggregated point cloud of over one million points. As used herein, the term “real time” means generally with no observable latency between processing and display. In a video-based scanning system, real time more specifically refers to processing within the time between frames of video data, which may vary according to specific video technologies between about fifteen frames per second and about thirty frames per second. More generally, processing capabilities of the computer 108 may vary according to the size of the subject 104, the speed of image acquisition, and the desired spatial resolution of three-dimensional points. The computer 108 may also include peripheral devices such as a keyboard 114, display 110, and mouse 112 for user interaction with the camera system 100. The display 110 may be a touch screen display capable of receiving user input through direct, physical interaction with the display 110.

Communications between the computer 108 and the scanner 102 may use any suitable communications link including, for example, a wired connection or a wireless connection based upon, for example, IEEE 802.11 (also known as wireless Ethernet), BlueTooth, or any other suitable wireless standard using, for example, a radio frequency, infrared, or other wireless communication medium. In medical imaging or other sensitive applications, wireless image transmission from the scanner 102 to the computer 108 may be secured. The computer 108 may generate control signals to the scanner 102 which, in addition to image acquisition commands, may include conventional camera controls such as focus or zoom.

In an example of general operation of a three-dimensional image capture system 100, the scanner 102 may acquire two-dimensional image sets at a video rate while the scanner 102 is passed over a surface of the subject. The two-dimensional image sets may be forwarded to the computer 108 for derivation of three-dimensional point clouds. The three-dimensional data for each newly acquired two-dimensional image set may be derived and fitted or “stitched” to existing three-dimensional data using a number of different techniques. Such a system employs camera motion estimation to avoid the need for independent tracking of the position of the scanner 102. One useful example of such a technique is described in commonly-owned U.S. Pat. No. 7,605,817 to Zhang, et al. However, it will be appreciated that this example is not limiting, and that the principles described herein may be applied to a wide range of three-dimensional image capture systems.

The display 110 may include any display suitable for video or other rate rendering at a level of detail corresponding to the acquired data. Suitable displays include cathode ray tube displays, liquid crystal displays, light emitting diode displays and the like. In some embodiments, the display may include a touch screen interface using, for example capacitive, resistive, or surface acoustic wave (also referred to as dispersive signal) touch screen technologies, or any other suitable technology for sensing physical interaction with the display 110.

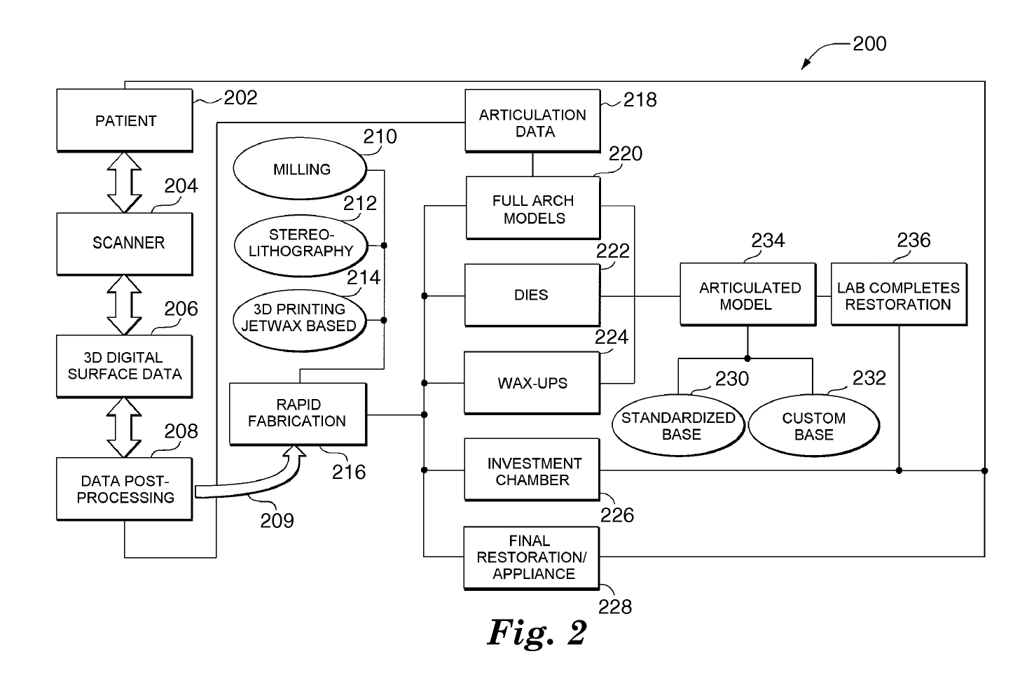

FIG. 2 is a conceptual block diagram of participants in a generalized manufacturing process for dental objects. The system 200 may begin with a patient 202 (for example, a dental patient) being scanned by a scanner 204, such as the scanner 102 and image capture system 100 described above, to obtain a digital surface representation 206 of one or more intraoral structures. This may include scans before and/or after a surface has been prepared to receive a dental restoration or other dental object. So, for example, a pre-preparation scan may be taken to capture a shape of the original anatomy and any occlusion information useful in creating a restoration, and a prepared surface scan may be taken to use as a basis for creating the restoration, and in particular for shaping the restoration to the prepared surface. Articulation data relating to the orientation and/or relative motion of an upper and lower arch may also be obtained through one or more scans of the arches in occlusion, or through other techniques such as still images or video of the arches in various orientations, or various dimensional measurements captured directly from the arches, or a physical bite registration captured on a thin sheet of material.

In one embodiment, a second scanner such as a PMD[vision] camera from PMD Technologies, may be employed to capture real-time, three-dimensional data on dynamic articulation and occlusion. While this scanner employs different imaging technology (time-of-flight detection from an array of LEDs) than described above, and produces results with resolution generally unsuitable for reconstruction of dental models, such a scanner may be employed to infer motion of, for example, opposing dental arches with sufficient resolution to select an axis for articulation or otherwise capture dynamic information that can be applied to two or more rigid bodies of a dental object scan. This data may be supplemented with more precise alignment data statically captured from digital or manual bite registration to provide reference or calibration points for continuous, dynamic motion data.

The digital surface representation 206 may be processed with one or more post-processing steps 208. This may include a variety of data enhancement processes, quality control processes, visual inspection, and so forth. Post-processing steps may be performed at a remote post-processing center or other computer facility capable of post-processing the imaging file, which may be, for example a dental laboratory. In some cases, this post-processing may be performed by the image capture system 100 itself. Post-processing may involve any number of clean-up steps, including the filling of holes, removing of outliers, etc.

Data enhancement may include, for example, smoothing, truncation, extrapolation, interpolation, and any other suitable processes for improving the quality of the digital surface representation 206 or improving its suitability for an intended purpose. In addition, spatial resolution may be enhanced using various post-processing techniques. Other enhancements may include modifications to the data, such as forming the digital surface representation 206 into a closed surface by virtually providing a base for each arch, or otherwise preparing the digital surface representation for subsequent fabrication steps.

In a quality control process, the digital surface representation 206 may be analyzed for the presence of holes or regions of incomplete or inadequate scan data. The digital surface representation 206 may also be automatically examined for unexpected curvature or asymmetry to a scanned arch, or other apparent defects in the acquired data. Other quality control processes may incorporate additional data. For example, a current scan may be compared to previous scans for the same patient. As another example, a selection of a dental restoration may be analyzed along with a scan of a tooth surface prepared for the restoration in order to evaluate the suitability of the surface preparation and any surrounding dentition for receiving the restoration. More generally, any process for evaluating data in the digital surface representation 206 with respect to its quality, internal consistency, or intended use, may be used in a post-processing quality control process.

The digital surface representation 206 may also be displayed for human inspection, such as by providing a perspective rendering of a point cloud of acquired surface data on a display.

Following any manual or automated post-processing, the resulting digital model may be transmitted to a rapid fabrication facility 216, as indicated by an arrow 209. This may include data in any suitable format, such as a stereolithography file for use in fabrication, or any other file format that can be processed by the rapid fabrication facility 216 to fabricate corresponding models. In addition, articulation data 218 in any suitable form may be transmitted for use in subsequent processing steps, as well as a prescription or other specification for manufacture of a restoration, appliance, hardware, and the like. The rapid fabrication facility 216 may be a dental laboratory, an in-house dental laboratory at a dentist's office, or any other facility with machinery to fabricate physical models from digital models. The rapid fabrication facility 216 may, for example, include a milling system 210, a stereo lithography system 212, Digital Light Processing (not shown), or a three-dimensional printer 214, or some combination of these. The milling system 210 may include, for example, a CNC milling machine. Milling systems may be used to take a block of material and create a variety of outputs, including full-arch models, dies, wax-ups, investment chambers or a final restoration or appliance. Such blocks may include ceramic-based, particle-board, wax, metals or a variety of other materials. Dental milling systems such as Procera from Nobel Biocare Inc. or Cerec from Sirona Inc. may also be used to create a final dental hardware component. The stereo lithography system 212 may include, for example, a Viper System by 3D Systems, Inc. The three-dimensional printer 214 may include, for example, an InVision HR printer from 3D Systems. Each of these fabrication techniques will be described in greater detail below. Other techniques for three-dimensional manufacturing are known, such as Fused Deposition Modeling, Laminated Object Manufacturing, Selective Laser Sintering, and Ballistic Particle Manufacturing, and may be suitably be adapted to use in certain dental applications described herein. More generally, three-dimensional fabrication techniques continue to become available. All such techniques may be adapted to use with the systems and methods described herein, provided they offer suitable fabrication resolution in suitable materials for use with the various dental objects described herein.

The rapid fabrication facility 216 may use the articulation data 218 and the digital model to generate one or more dental objects, such as one or more full arch models 220 (of an upper arch, a lower arch, or both), one or more dies 222, one or more waxups 224, one or more investment chambers 226, and/or one or more final restorations or appliances 228. Some components, such as the dies 222 and arches 220, may be inserted into an articulated model 234 such as an articulator with a standard base 230 or a custom base 232. Articulators and articulated models are described in greater detail below. A dental laboratory may employ these various components to complete a restoration 236, which may be returned to a dentist for placement into/onto the dentition of the dental patient.

Various aspects of this system and process will now be described in greater detail, beginning with the computerized fabrication systems that may be employed with the systems and methods described herein.

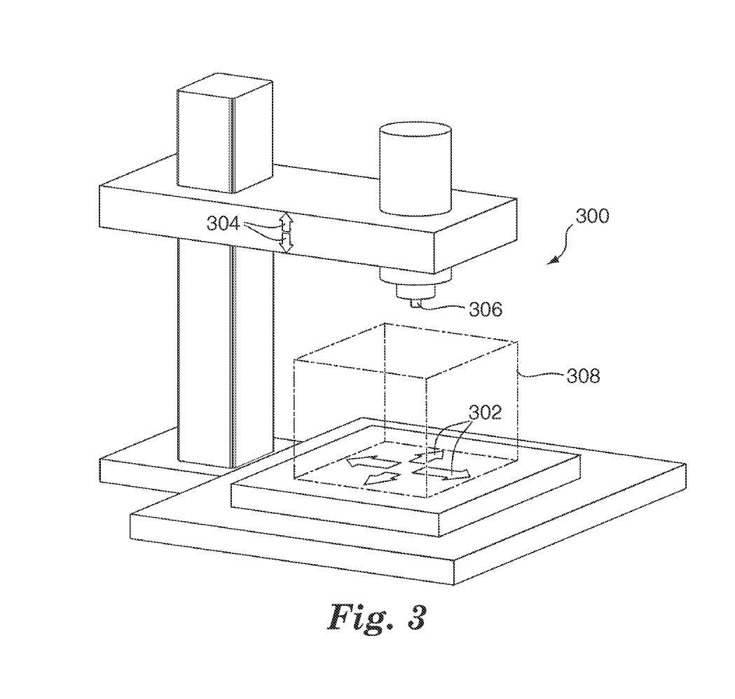

FIG. 3 shows a milling machine that may be used with the systems and methods herein. In particular, FIG. 3 illustrates a Computerized Numerically Controlled (“CNC”) milling machine 300 including a table 302, an arm 304, and a cutting tool 306 that cooperate to mill under computer control within a working envelope 308. In operation, a workpiece (not shown) may be attached to the table 302. The table 302 may move within a horizontal plane and the arm 304 may move on a vertical axis to collectively provide x-axis, y-axis, and z-axis positioning of the cutting tool 306 relative to a workpiece within the working envelope 308. The cutting tool 306 may thus be maneuvered to cut a computer-specified shape from the workpiece.

Milling is generally a subtractive technology in that material is subtracted from a block rather than added. Thus pre-cut workpieces approximating commonly milled shapes may advantageously be employed to reduce the amount of material that must be removed during a milling job, which may reduce material costs and/or save time in a milling process. More specifically in a dental context, it may be advantageous to begin a milling process with a precut piece, such as a generic coping, rather than a square block. A number of sizes and shapes (for example, molar, incisor, etc.) of preformed workpieces may be provided so that an optimal piece may be selected to begin any milling job. Various milling systems have different degrees of freedom, referred to as axes. Typically, the more axes available (such as 4-axis milling), the more accurate the resulting parts. High-speed milling systems are commercially available, and can provide high throughputs.

In addition a milling system may use a variety of cutting tools, and the milling system may include an automated tool changing capability to cut a single part with a variety of cutting tools. In milling a dental model, accuracy may be adjusted for different parts of the model. For example, the tops of teeth, or occlusal surfaces, may be cut more quickly and roughly with a ball mill and the prepared tooth and dental margin may be milled with a tool resulting in greater detail and accuracy. In general, milling systems offer the advantage of working directly with a finished material so that the final product is free from curing-related distortions or other artifacts. As a disadvantage, a high precision requires smaller cutting tools and correspondingly slower fabrication times.

CNC milling and other milling technologies can be employed for manufacturing dental models, dental model components, wax-ups, investment chambers, and other dental objects, some of which are described in greater detail below. In addition specialty dental milling equipment exists, such as the Cerec system from Sirona Dental. Another useful milling system for the dental fabrication processes described herein is a copy milling system that permits manual or automated transfer of a three-dimensional form from a physical object to a milled target.

All such milling systems as may be adapted to use as a computer controlled fabrication system in the dental applications described herein are intended to fall within the scope of the term “milling system” as used herein, and a milling process may employ any of the milling systems described herein.

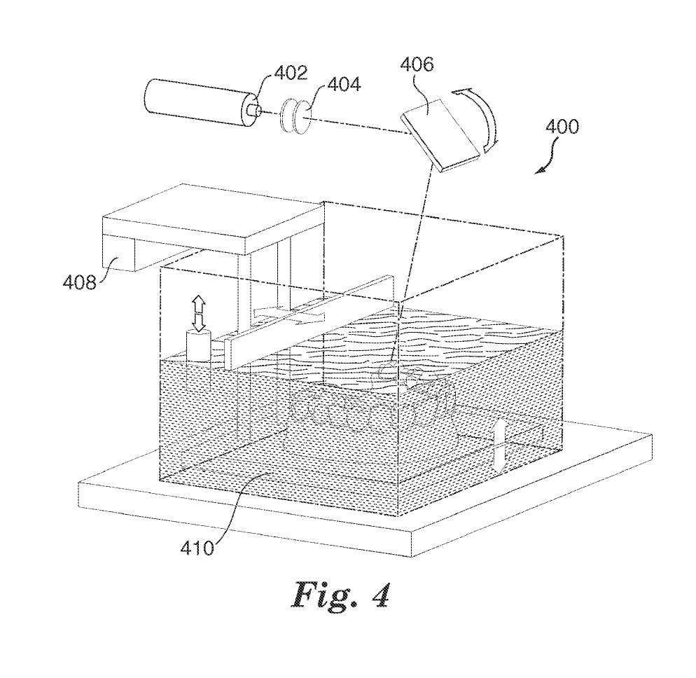

FIG. 4 shows a stereo lithography apparatus (“SLA”) that may be used with the systems and methods described herein. In general, the SLA 400 may include a laser 402, optics 404, a steering lens 406, an elevator 408, a platform 410, and a straight edge 412, within a vat 412 filled with a polymer. In operation, the laser 402 is steered across a surface of the polymer to cure a cross-section of the polymer, typically a photocurable liquid resin, after which the elevator 408 slightly lowers the platform 408 and another cross section is cured. The straight edge 412 may sweep the surface of the cured polymer between layers to smooth and normalize the surface prior to addition of a new layer. In other embodiments, the vat 412 may be slowly filled with liquid resin while an object is drawn, layer by layer, onto the top surface of the polymer. One useful commercial embodiment of an SLA is the SCS-1000HD available from Sony Corporation.

Stereo lithography is well-suited for the high volume production of dental models and dies, because parts may be batched on machines for rapid production. When optimized, these parts may be used in lieu of plaster dental models and other dental objects. An SLA may be usefully employed for fabrication of dental models, arches and cast-able parts, as well as for other high-accuracy and/or high-throughput applications. In some embodiments an SLA may receive a digital surface representation directly from a clinician's intraoral scan, and manufacture a dental model corresponding to the patient's dentition with or without surrounding soft tissue. Where groups of related objects are manufactured, they may be physically interconnected during the SLA process so that a complete set or kit is readily handled after fabrication. Individual pieces of the kit may be separated and trimmed or finished as appropriate, such as by a qualified technician in a dental laboratory. In such embodiments, dental objects may be oriented so that the interconnecting frame or other mechanical infrastructure only contacts objects on non-critical surfaces. Thus, for example, connections might be avoided on opposing surfaces of a dental arch where fine detail is to be preserved.

An SLA may require significant optimization of operating parameters such as draw speeds, beam diameters, materials, etc. These parameters may be stored in a “style” file, which may also vary accuracy and speed in different areas of a model. So, for example, a tooth within an arch that contains a surface prepared for a dental prosthetic may be optimized for detail/accuracy, while a distant tooth on a different arch may be optimized for speed.

A related technology, Digital Light Processing (“DLP”), also employs a container of curable polymer. However, in a DLP system, a two-dimensional cross section is projected onto the curable material to cure an entire transverse plane at one time. DLP fabrication currently provides resolution on the order of 40 microns, with further sub-pixel accuracy available using a number of techniques.

All such curable polymer systems as may be adapted to use as a computer controlled fabrication system in the dental applications described herein are intended to fall within the scope of the term “stereolithography system” as used herein, and a stereolithography process may employ any of the stereolithography systems described herein.

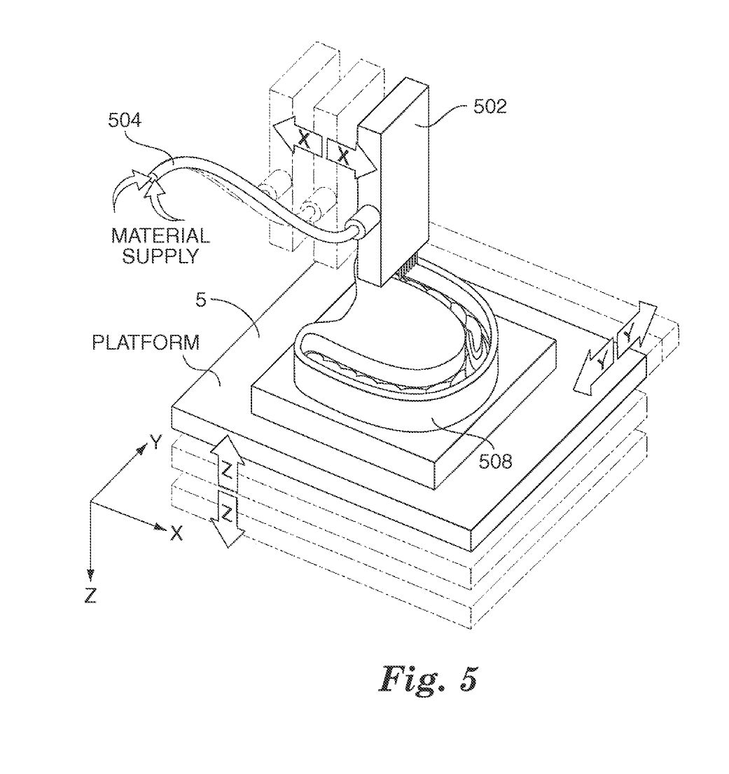

FIG. 5 shows a three-dimensional printer. The three-dimensional printer 500 may include a print head 502, a material supply 504, a platform 506, and positioning mechanisms (not shown) such as elevators, arms, belts, and the like that may be used to position the print head 502 relative to a printed item 508 during a printing operation. In operation, the print head 502 may deposit curable photopolymers or powders in a layer-by-layer fashion.

Various types of three-dimensional printers exist. Some printers deposit a polymer in conjunction with a support material or a bonding agent. In some systems, the stage may move as well to control x-y motion of the print head 502 relative to the platform 506 and printed item 508. Models printed on such systems may require finishing steps, such as removal of wax supports and other cleaning processes. Three-dimensional printers are well suited to rapid fabrication of small parts such as wax patterns or wax-ups, as well as dies and other relatively small dental objects. One commercial system suitable for three-dimensional dental printing applications is the InVision HR printer from 3D Systems.

Three-dimensional printing may be usefully employed for fabricating a variety of dental objects including wax-ups that may be cast by a dental laboratory to create a traditional metal substructure restoration, often referred to as a Porcelain-Fused-to-Metal (“PFM”) restoration. Direct three-dimensional printing of the wax-up (much of the shape of which may be directly inferred from a digital surface representation of a patient's dentition) may omit intermediate processing steps in conventional dentistry, where the shape of the dentition travels from an impression to a model to a wax-up. This approach advantageously prevents loss or corruption of data between the source (the patient's dentition) and the target wax-up by transitioning directly from an intraoral scan to a waxup, bypassing intermediate processing steps. Other useful applications of three-dimensional in computer controlled fabrication of dental objects will be readily appreciated by one of ordinary skill in the art, and all such applications are intended to fall within the scope of this disclosure.

It will be appreciated that other computer controlled fabrication systems are known in the art. Thus, the terms fabricate, fabricating, and fabrication, as used herein, will be understood to refer to the fabrication technologies above, as well as any other computer controlled manufacturing technology that might be adapted to manufacture of custom dental objects, including, without limitation, selective laser sintering (“SLS”), fused deposition modeling (“FDM”), laminated object manufacturing (“LOM”), and so forth, unless a different meaning is explicitly provided or otherwise clear from the context. Similarly, any of the above technologies, either alone or in combination, may operate as a means for fabricating, printing, manufacturing, or otherwise creating the dental objects described herein. It will be appreciated that the fabrication steps described above with reference to particular technologies may be followed by additional steps such as curing, cleaning, and so forth to provide a final product.

The manufacturing techniques described above may be combined in various ways to provide a multimodal fabrication process. Thus, for example, a CNC milling machine may be used to create a die for a tooth requiring greater detail than an SLA can provide, while the SLA may be employed for a model of a dental arch that contains the die. This multimodal approach may deploy the advantages of various technologies in different aspects of the fabrication process, such as using stereolithography for speed, milling for accuracy, and three-dimensional printing for high-speed fabrication of small parts. Other mass production techniques such as injection molding may also or instead be employed for fabrication of certain standard (that is, non-customized) model components such as an articulating hinge.

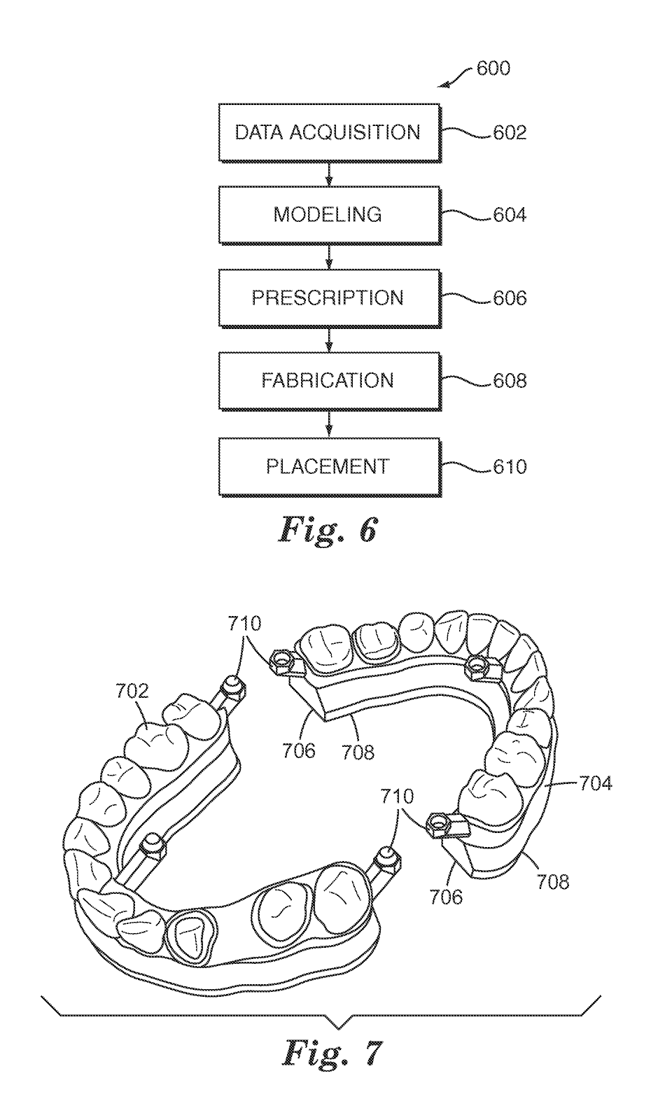

FIG. 6 is a high-level flow chart of a dental object fabrication process. This process 600 employs a three-dimensional representation of dentition acquired directly from an intraoral scan, and advantageously bypasses a number of processing steps used in conventional dentistry.

In general the process 600 may begin with data acquisition, as shown in step 602. Data acquisition may include any acquisition of a digital surface representation, or other three-dimensional or other representation of dentition suitable for use in a dental object fabrication process. The data acquisition may be performed using, for example, the scanner 102 and image capture system described above with reference to FIG. 1. In certain embodiments, a number of different scans may be acquired, such as scans to establish articulation and occlusion of arches, or scans before and after a surface preparation, which may be used jointly to create a prosthetic or the like. For example, to establish articulation and occlusion of arches, scans may be made of the upper and lower arches, and a bite scan may be taken with the upper and lower arches in various types of occlusion and so forth. Used jointly, these scans may provide full detail for an upper and lower arch, along with static and dynamic data concerning the alignment and motion of the arches.

Once suitable data has been acquired, one or more modeling operations may be performed, as shown in step 604. This may include modeling steps such as ditching a virtual die of a digital dental model, specifying a tooth for treatment, filling holes or otherwise correcting data, bite registration, and/or fully designing a restoration, prosthetic, hardware or other dental object(s), as well as any other modeling or digital model manipulation useful in a dental context. Modeling may be performed using commercially available Computer Automated Design (“CAD”) or other three-dimensional modeling tools, or special-purpose dental modeling software such as the in Lab CAD/CAM system from Sirona.

For example, modeling may include bounding the surface representation to form a solid, and then creating a void space, or collection of void spaces within the solid that do not affect dentally significant surfaces such as the dentition or surrounding soft tissue. This may advantageously result in significant reductions in material required to fabricate a dental model from the voided digital model, thus reducing material costs as well as time to manufacture dental models.

Modeling for articulated models may include using scan data together with bite registration and other data to position two rigid bodies corresponding to opposing arches in a relative orientation corresponding to the position of the arches in a dental patient's mouth. Once so aligned, the arches may be mechanically registered to a common reference surface that corresponds to, for example, the top and bottom of a dental articulator. This process is described in greater detail below. Modeling may also or instead include the addition of a flat back surface on each of two opposing arches to provide a fixed reference plane to which an articulating hinge can be attached.

More generally, it will be appreciated that the term “modeling” as used herein may refer to any processing of a digital dental model including fully automated, semi-automated, and/or manual processes such as those noted throughout this description.

As shown in step 606, a prescription may be prepared. This specifies a type of restoration, prosthetic, or the like, and may include a variety of additional information related to a manufacturer, color, finish, die spacing, and so forth. It will be appreciated that the prescription step 606 may be performed before the modeling step 608, such as in a process where a dentist transmits the initial digital surface representation from a patient to a dental laboratory along with a prescription, leaving some or all of the modeling to the dental laboratory.

As shown in step 608, one or more dental objects may be fabricated. Fabrication may be performed using any of the fabrication technologies described above, either alone or in various combinations, using data from one of the modeling systems described above, which may be reformatted or otherwise adapted as necessary for a particular printing, milling, or other fabrication technology. Also, as will be clear from some of the examples below, fabrication may include a combination of different fabrication technologies. For example, a dental model may be three-dimensionally printed with a space for a die, while the die may be fabricated using stereolithography and an articulating hinge may be fabricated using injection molding. Thus, the term “fabrication” as used herein is intended to refer to any suitable fabrication technology unless a specific fabrication technology is explicitly identified, or otherwise clear from the context. A number of specific fabrication examples are discussed below in greater detail.

As shown in step 610, a prosthetic or other dental object may be returned to a dentist for placement into a patient's dentition.

It will be appreciated that the steps above may be re-ordered or modified, or steps may be added to or removed from the above process, all without departing from the scope of this disclosure.

FIG. 7 shows an upper and lower arch of a dental model. In general, a model 700 of a dental arch of a dental patient may include an upper arch 702 or a lower arch 704, with both arches depicted for reference. It will be appreciated that the term “model” is used herein interchangeably to refer to a single arch or two opposing arches, and may include or exclude dies, hinges and other components attached to or otherwise associated with the model. In addition, the description of various model features may refer to features of a digital model stored in a computer memory, or to the features of a physical model fabricated according to the digital model, or to both. Thus the term “model” is intended to include all such meanings unless a specific meaning is explicitly provided or otherwise clear from the context.

In general, the model 700 may be derived from a digital surface representation of the dentition of a patient, captured for example using any of the techniques described above. The actual data acquired from the dental patient may be supplemented with filling, smoothing, surface bounding, and so forth, to provide a digital model suitable for processing, editing, manipulation, and the like, and ultimately for fabrication as any of the components described herein.

A flat surface 706 on a back 708 of the dental arch 704 may be added during a modeling step as described above and/or fabricated into a physical model (two are shown, on each end of the dental arch 704). Each dental arch 702, 704 generally has a back 708 (from the dental patient's point of view) where two ends of the dental arch 702, 704 support molars and the like. The flat surface 706 may provide a mounting surface for attaching an articulating hinge or the like using an adhesive or any other suitable attachment mechanism. The flat surface 706 may in general be positioned and oriented in the model 700 so that the upper arch 702 and the lower arch 704 are in a desired occlusion when attached to a hinged articulator having a standard, known shape. While a flat surface 706 provides one convenient and flexible mounting alternative, it will be appreciated that a variety of techniques may be suitably adapted to mechanically couple the dental arches 702, 704 to an articulating hinge using, for example, pins, dowels, dovetails, protrusions, slots, grooves, or other features or combination of features, and all such techniques are intended to fall within the scope of this disclosure.

Although described above as a single flat surface 706, the back 708 of the dental arch 704 may have two terminal ends (as illustrated) interconnected by the arching jawbone. Thus in one aspect, the model 700 of the dental arch 702, 704 extends from a first back end with a first flat surface to a second back end with a second flat surface (also identified as a flat surface 706 and a back end 708 in FIG. 7). The first flat surface and the second flat surface may be substantially coplanar, or have any other desired orientation relative to one another for connection to a hinged articulator. Also as noted above, each back surface of a dental arch may include any feature or combination of features suitable for mechanically coupling to an articulator.

The model may include a kinematic coupling 710 using any of a variety of suitable coupling features or fixtures. Kinematic coupling is generally known as a technique for aligning different parts. As used herein, the term “kinematic coupling” is intended to refer to any of a variety of such techniques used to mechanically constrain the relative position of two components under a load including without limitation kinematic coupling, planar kinematic coupling, quasi-kinematic coupling, elastic averaging techniques, pin joints or any other similar technique(s). In the model described herein, the kinematic coupling 710 may for example include three coupling locations each using coupling fixtures having complementary shapes of a truncated cone. A variety of other shapes such as a ball and groove, ball and circle, and so forth may also or instead be employed for a kinematic coupling as described herein.

The coupling locations for the fixtures of the kinematic coupling 710 may, for example be located at three coplanar positions between the upper and lower arches. The coupling locations may more generally be arbitrarily selected in a virtual modeling environment such as that described above. However selected, the kinematic coupling may be positioned, and the coupling fixtures may be connected to the dental arches 702, 704 using stems, arms, or other protrusions within the virtual modeling environment while the upper arch 702 and the lower arch 704 are in a desired occlusal relationship. The desired occlusal relationship may be determined from a bite registration or the like from the dental patient. Thus the kinematic coupling 710 may be used to transfer a bite registration from a dental patient to a dental model for that dental patient, or more specifically to provide a bite registration between one model such as the upper arch 702 and another model such as the lower arch 704. In this manner, the arches 702, 704 can be aligned mechanically with the kinematic coupling 710, and then attached to an articulating hinge or the like while in the desired orientation. The kinematic coupling 710 may be cut away, broken off, or otherwise removed after the articulating hinge has been attached.

Certain relative terms are used herein to describe orientation such as top, bottom, upper, and lower. It will be appreciated that two arches in occlusion have a mirrored orientation relative to one another such that a “top” portion of a die in a lower arch would be a “bottom” portion of a die in an upper arch from the point of view of a dental patient, even though the term “top portion” as used herein generally refers to the portion of a tooth that has an exposed tooth surface as distinguished from the “bottom portion” which generally refers to the root that engages the tooth with a jaw bone. While these relative terms are used herein for explanatory and illustrative purposes, nothing in this description should be construed as limiting this disclosure to an upper arch or a lower arch, or to an arch in any particular orientation, or to the use of full arch models, or models in occlusion of any form, except as explicitly stated or otherwise clear from the context.

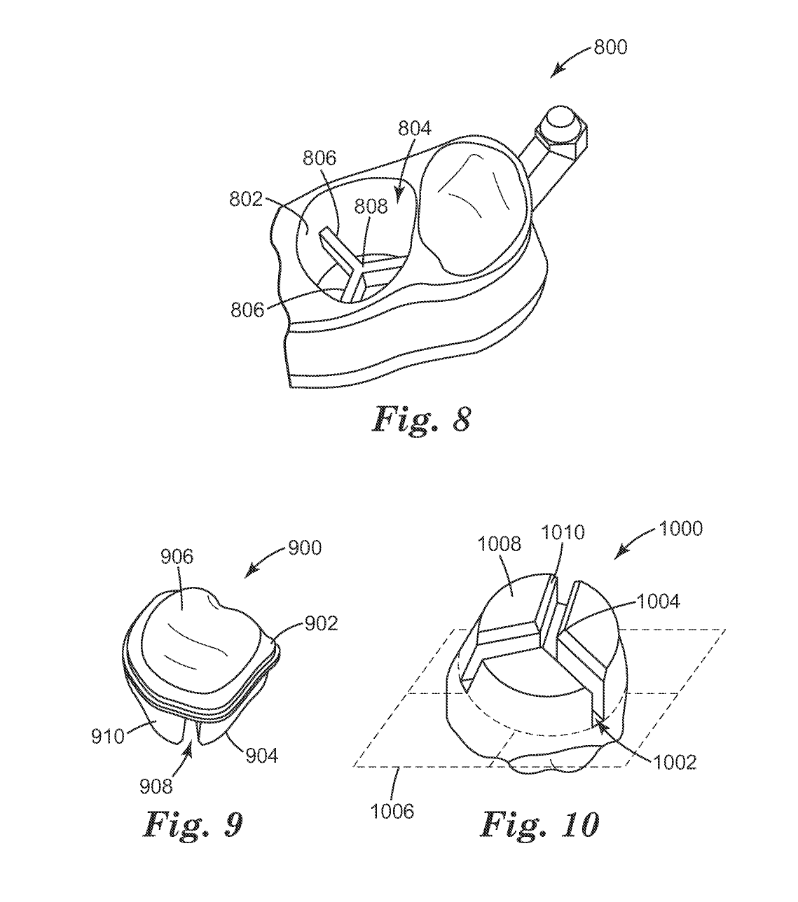

FIG. 8 shows a dental model of an arch. The model 800 may in general be the upper arch or lower arch described above. The model 800 may be a digital model, or the model 800 may be a physical model fabricated using stereolithography or any other suitable fabrication process.

In order to receive a die, the model 800 may include an opening 802 for the die. The opening 802 may have an open bottom so that it passes entirely through the model 800 or the opening 802 may have a closed bottom. The opening 802 may have any suitable cross-sectional shape through a horizontal transverse plane of the model 800. For example, the opening 802 may be circular, oval, or any other regular or irregular shape having straight sides, one or more curvilinear sides, or some combination of these. In one aspect, a curved, non-circular shape can help to align the rotation and x, y position of a corresponding die by imposing a desired location and orientation on the die for proper fit.

The opening 802 may be bounded by an interior wall 804 which is generally shaped to complement a die for the opening 802. The interior wall 804 may be tapered to receive the die so that a top of the interior wall 804 (where the die enters the opening 802) is larger than a bottom of the interior wall 804 so that the opening 802 has a progressively decreasing cross-sectional area from top to bottom. With this general shape, the die becomes increasingly constrained as it moves further into the opening 802. This configuration provides an element of mechanical registration for the die in the model 800 while still permitting relatively easy assembly. In one aspect, a linear taper is used from the top of the interior wall 804 to the bottom of the interior wall 804; however, any taper may be used that monotonically progresses from a smaller bottom of the opening toward a larger top of the opening. For a die with a complementary shape, the taper can help to correctly position a die vertically within the model 800, that is, along the z-axis of the transverse plane, by physically engaging the die about an entire circumference of the interior wall 804, or substantially an entire circumference, when the die is at the correct depth.

The opening 802 may include a plurality of support members 806 that extend from the side wall 804 to a common location 808 within the opening. The support members 806 may establish a reference shape for mechanical registration of a die in the correct x, y, and z position and rotation within the model 800. As illustrated, a top surface of the support members 806 generally defines a transverse or horizontal plane through the model 800. This top surface provides a useful reference for correct z-position of the die without the use of any large, flat, horizontal surfaces that might interfere with the accuracy of a stereolithography process or the like. In general, the support members 806 may join at the common location 808 to form a more rigid structure than individual, disjointed protrusions.

The drawings are illustrative only, and numerous variations to the support members 806 are possible without departing from the scope of this disclosure. For example, the support members 806 may be positioned at any depth within the opening 802 suitable to support a die in the opening 802. As another example, while the common location 808 is illustrated near a center of the opening 808, no specific position of the common location 808 is required, and the common location 808 may be any suitable location within the opening 802. Also, while the support members 806 join at the common location 808 in a transverse plane through the model 800 and opening 802, each support member 806 may nonetheless have a different height or z-axis position relative to the transverse plane, provided there is sufficient overlap to structurally join the support members 806 into a rigid structure. While three support members 806 are illustrated, any suitable number of support members 806 may be employed. Other variations will be apparent, and are intended to fall within the scope of this disclosure.

FIG. 9 shows a top perspective view of a die. The die 900 generally has a top portion 902 and a bottom portion 904.

The top portion 902 may have a surface 906 formed into a shape of dentition for a dental patient. This may be actual dentition of the dental patient acquired with a three dimensional scanner or the like. Actual dentition may include a tooth (or teeth) prior to preparation for a restoration, or a tooth (or teeth) after preparation for a restoration. The dentition may also be computer-created or physically modeled dentition such as a shape desired for a tooth (or teeth) after a restoration. More generally, any exterior dental surface, or any subsurface or other intermediate processing shape useful in the creation of a restoration or the like may be used as a shape for the surface 906 of the top portion 902.

The bottom portion 904 may be tapered to fit into an opening of a model as generally discussed above. The bottom portion 904 may also include a number of slots 908 that extend vertically from a transverse plane within the die 900 to a bottom surface of the bottom portion 904. The slots 908 may also extend radially from a common location within the die 900 to a side wall 910 of the bottom portion 904. More generally, the slots 908 may have any shape and orientation suitable for engaging the support members within an opening of a model as described above. In one aspect, three slots 908 may be used; however the die 900 may include any number of slots 908 suitable for supporting the die 800 in a model.

FIG. 10 shows a bottom perspective view of a die. The die 1000 may be any of the dies discussed above. The die 1000 may, as described above, include a number of slots 1002, and each of the slots 1002 may extend radially from a common location 1004 to a side wall of the die 1000, and vertically from a transverse plane 1006 to a bottom surface 1008 of the die 1000. Each slot 1002 may includes a bottom opening where the slot 1002 meets the bottom surface 1008. The bottom opening may have beveled edges 1010 or any similar feature that guides the die 1000 into engagement with corresponding support members of an opening in a model as described above. The beveled edges 1010 may advantageously serve to increase a capture distance for the slots by support members of a corresponding opening. The capture distance is generally the distance that the die 1000 can be out of alignment and still be “captured” by the corresponding support members for correct mechanical registration as the parts are moved into engagement. Capture distance may also or instead be expressed in terms of rotational misalignment.

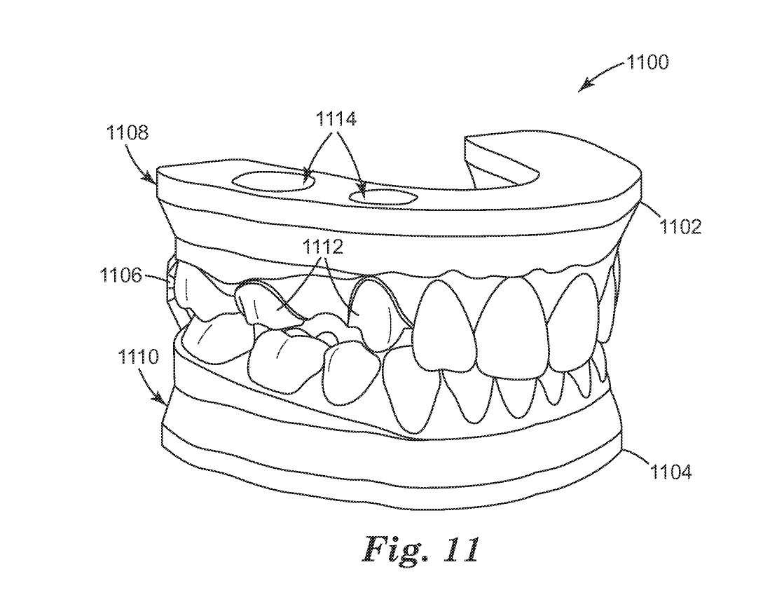

FIG. 11 shows an upper arch and a lower arch of a dental model in occlusion. The full dental model 1100 may include a model 1102 and a second model 1104 representing an upper and lower arch. When aligned by a kinematic coupling 1106 (only one coupling fixture of the kinematic coupling 1106 is visible in the drawing) as described above in a desired occlusal relationship, the model 1102 and the second model 1104 may present a pair of coplanar mounting surfaces 1108, 1110 for attaching an articulating hinge or other fixture to retain the models 1100, 1102 in a desired static or dynamic (for example, articulating) relationship. It will also be noted that FIG. 11 shows two dies 1112 positioned in two openings 1114 of the model 1102, as they might be while a dental laboratory or the like is working on fabrication of a restoration for corresponding teeth.

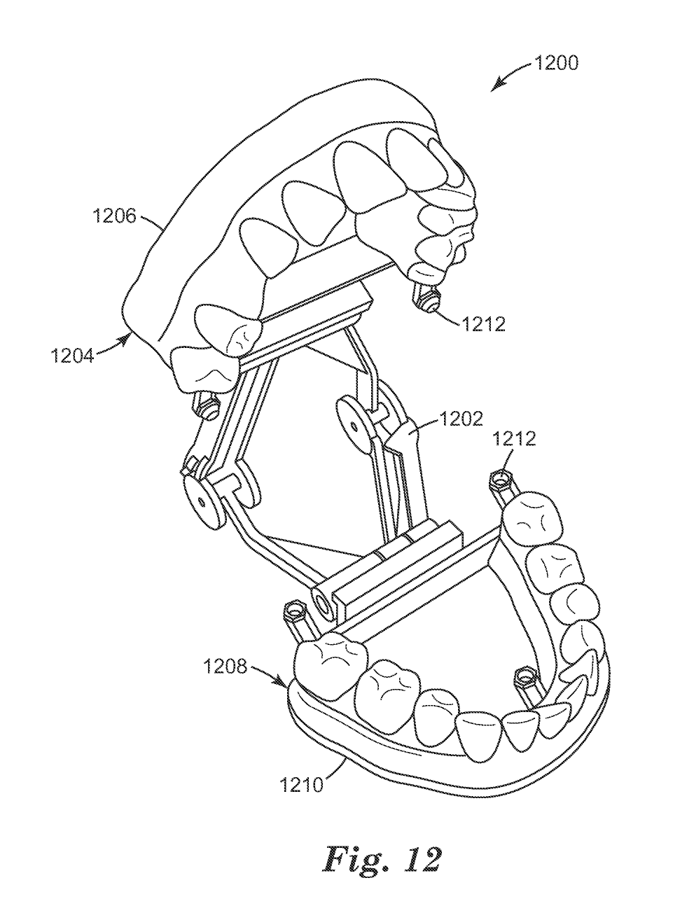

FIG. 12 shows an upper arch and a lower arch of a dental model 1200 with an articulating hinge 1202. In general, the articulating hinge 1202 may be attached to a back surface 1204 of a model 1206, and to a second back surface 1208 of a second model 1210. The articulating hinge 1202 will typically support the model 1206 and the second model 1210 in a desired occlusal relationship, so the coupling fixtures of the kinematic coupling 1212 may be cut away, broken off, or otherwise detached from the dental model 1200 once the articulating hinge 1202 is attached. The articulating hinge 1202 generally includes complementary mounting surfaces for attachment to the first model 1206 and the second model 1210, and includes a hinging mechanism and two arms extending from the hinging mechanism to functionally reproduce dynamic articulation or movement of the respective jaws of actual dentition represented by the dental model 1200. The hinging mechanism and the two arms may be adjustable to control a radius of articulation, range of articulation, resistance to movement, and any other aspects of articulation and/or dynamic and static occlusion that might be useful to a dental laboratory or the like preparing a restoration. While a particular articulating hinge 1202 is shown, it will be appreciated that any articulating hinge 1202 suitable for use in a dental restoration process may usefully be employed without departing from the scope of this disclosure.

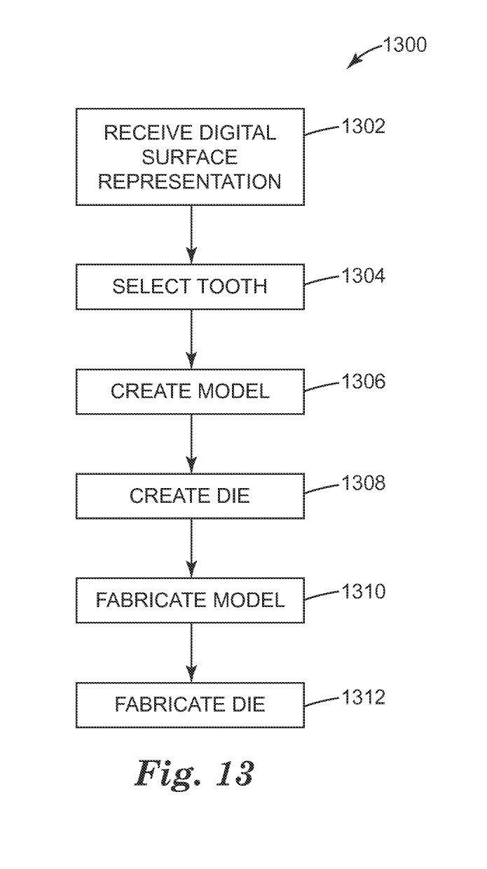

FIG. 13 shows a process for fabricating a model and/or die. In the following description, the term “digital model” may be used interchangeably to refer to a digital model of an arch, a digital model of a die, or both.

The process 1300 may begin with receiving a digital surface representation for a dental arch of a dental patient from a three-dimensional scanner, as shown in step 1302. This may include directly receiving digital data from a scanner such as the scanner described above or any other suitable data source while a scan is acquired, or this may include retrieving a scan, or a processed version of a scan from a computer memory. The digital surface representation may include any refinements obtained during a modeling step as described above, such as smoothing, hole filling, and the like. However obtained, the digital surface representation will generally include surface data characterizing dentition of a dental patient.

As shown in step 1304, the process 1300 may include selecting a tooth in the dental arch for a restoration. This step may be performed, for example, using an interactive user interface for model creation, or any other suitable interface for a user to specify a tooth for a restoration or other procedure. This step may be automated using suitable data processing so that a user can affect a single point and click operation within an interface to select a tooth in a digital dental model displayed on a screen or the like. In another aspect, a user may manually identify some or all of the boundaries of a tooth in a two-dimensional or three-dimensional display.

As shown in step 1306, the process 130 may include creating a digital model of the dental arch to provide a digital arch model. This may include receiving a digital model of a dental arch suitable for fabrication, or processing a digital surface representation of dentition to provide a digital model suitable for fabrication. This may also include creating an opening for a tooth such as the tooth selected in step 1304. The opening may include a side wall tapered to receive a die and a plurality of support members extending from the side wall to a common location within the opening, all as generally described above.

Step 1306 may include a number of additional modeling steps, any of which may be performed manually within a user interface of a computer or, where appropriate, semi-automatically or fully automatically. This may include, for example, aligning a dental arch to an opposing arch according to a bite registration of the dental patient. A variety of techniques may be used to capture a bite registration and transfer this bite registration to the digital model. For example, a bite registration may be captured using a thin film into which a patient bites to provide a two-dimensional record of the relative alignment of upper and lower arches at any contact point(s). As another example, one or more digital three-dimensional scans may be obtained that span the upper and lower arches in a desired occlusion. These cans may be three-dimensionally registered to independent digital models of an upper and lower arch to reproduce the occlusion of the bite registration in the computerized modeling environment.

In another aspect, various features of the models described above may be added to the digital arch model. For example, two coplanar surfaces may be formed on a back surface of each of the dental arch and an opposing arch for attachment of an articulating hinge using, for example, a conventional planar cutting tool in a three-dimensional modeling environment. Thus alignment of two arches may generally be performed in a computer environment. In another aspect, the aligning of arches for subsequent cutting of planar rear surfaces and/or attachment to an articulator may be performed using a physical realization of the digital arch model. Thus for example, a bite registration film may be used to physically align the arch models, after which a planar back surface may be cut and an articulating hinge may be used to secure the arches in the desired orientation. In another aspect, a kinematic coupling such as any of the kinematic couplings described above may be added to the digital dental model when the opposing arches are aligned according to a bite registration. In this manner, a physical realization of the digital model and the second digital model can be aligned according to the bite registration with the kinematic coupling after the pieces are separately fabricated.

As shown in step 1308, the process 1300 may include creating a digital model of a die for the restoration. In general, the die may include a top portion having a surface formed into a shape of dentition for the dental patient, a bottom portion tapered for insertion into an arch model of the dental arch, and a number of slots that extend vertically from a transverse plane within the die to a bottom surface of the bottom portion and radially from a common location within the die to a side wall of the bottom portion, all as described above. This may include a user selection a shape for the surface on the top portion of the die, such as a pre-preparation surface, a post-preparation surface, or a computer generated surface (which may be manually, semi-automatically, or automatically create) such as the desired final surface for a restoration or a surface for an intermediate processing step used to fabricate the restoration. The process 1300 may include modeling a die and then imposing the shape of the die onto a digital arch model, or conversely modeling an opening in a dental arch and then imposing the shape of the opening onto the die. In another aspect, the creation of models for the die and the arch may be fully automated so that when a user selects a tooth, the complementary support members and slots, as well as a tapered shape, are applied to both the die and the arch. In another aspect, the margin between the selected tooth and the gum line of the arch may be automatically, semi-automatically, or manually identified to provide a line for a boundary between the die and the arch model. This line may be used to establish the shape of the top of the opening, which cross-sectional shape may also be projected in a tapered manner to at least the bottom of the die.

In another aspect, various features of the models described above may be added to the digital model of the die. This may, for example, include manual, semi-automatic, or fully automated addition of beveled edges to the slots of the die.

As shown in step 1310, the process may include fabricating a dental model for an arch. This may include fabricating the digital arch model described above using any suitable computer controlled fabrication process such as stereolithography, computerized milling, three-dimensional printing, and so forth. In one aspect, this may include preparing a stereolithography file or other fabrication-ready representation of the dental model. This may also or instead include transmitting the digital arch model (and/or the fabrication-ready representation) to a fabrication facility. In another aspect, this may include controlling a computerized fabrication system to fabricate a physical model from the digital arch model.

As shown in step 1312, the process may include fabricating the die from the digital model using a computerized fabrication process. This may include fabricating the digital model of the die described above using any suitable computer controlled fabrication process such as stereolithography, computerized milling, three-dimensional printing, and so forth. In one aspect, this may include preparing a stereolithography file or other fabrication-ready representation of the digital model. This may also or instead include transmitting the digital model (and/or the fabrication-ready representation) to a fabrication facility. In another aspect, this may include controlling a computerized fabrication system to fabricate a physical model of the die from the digital model.

Thus a number of processes have been described for modeling and fabricating the dies and corresponding arch models described above. These processes are provided by way of example and not of limitation. The steps above may be re-ordered or modified, or steps may be added to or removed, all without departing from the scope of this disclosure. For example, while a single-tooth process is described in detail, multiple dies for multiple teeth may be concurrently prepared for a single dental patient, or multiple dies may be prepared for various restoration processing steps for a single restoration of a single tooth. As another example, different fabrication techniques may be used for the die and the dental arch model according to varying requirements for cost, speed, accuracy, and any other criteria.

It will also be understood that each step, or sub-step thereof, may be realized in a number of different forms. For example, where a step is realized as a computer program product, the step will generally include a computer program product comprising computer executable code embodied on a non-transitory computer readable medium (such as a memory of any of the computers described above, or a compact disc, optical memory, USB memory device, or any other suitable non-transitory storage medium) that, when executing on one or more computing devices performs the corresponding step(s). Thus in one aspect there is disclosed herein a computer program product for creating and/or fabricating a digital model of a die as described herein. In another aspect there is disclosed herein a computer program product for creating and/or fabricating a digital arch model as described herein. Where a method recites operations on or interactions with a computerized model, it will be understood that such method steps may generally include the use of a user interface generated by a computer and rendered on a display for user interaction using a keyboard, mouse, or the like. Thus even where no hardware is articulated, each such step may include hardware controlled according to software to provide a machine that performs the recited step(s) or function(s). It will further be appreciated that even where no hardware is articulated, each such step also generally relates to a transformation (using intermediate digital models) from physical dentition of a dental patient to a physical dental model for a restoration for the dental patient.

Still more generally, it will be appreciated that the above processes may be realized in hardware, software, or any combination of these suitable for the data acquisition, modeling, and fabrication described herein. This includes realization in one or more microprocessors, microcontrollers, embedded microcontrollers, programmable digital signal processors or other programmable devices, along with internal and/or external memory. This may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as computers variously located in a dental office, a dental laboratory, and a fabrication facility or all of the functionality may be integrated into a dedicated, standalone device. All such permutations and combinations are intended to fall within the scope of the present disclosure.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

1. A die for use in a dental model, the die comprising:
a top portion having a surface formed into a shape of dentition for a dental patient;
a bottom portion tapered for insertion into an arch model; and
a plurality of slots that extend vertically from a transverse plane within the die to a bottom surface of the bottom portion and radially from a common location within the die to a side wall of the bottom portion.

2. The die of claim 1 wherein the surface is formed into the shape of a tooth of the dental patient prior to preparation for a restoration.

3. The die of claim 1 wherein the surface is formed into the shape of a tooth of the dental patient after preparation for a restoration.

4. The die of claim 1 wherein the surface is formed into the shape desired for a tooth after a restoration.

5. The die of claim 1 wherein each one of the plurality of slots has a bottom opening with beveled edges to increase a capture distance of the plurality of slots by a plurality of support members in an opening of an arch model.

6. The die of claim 1 wherein the plurality of slots includes three slots.

7. A method for fabricating a die comprising:
receiving a digital surface representation for a dental arch of a dental patient from a three-dimensional scanner;
selecting a tooth in the dental arch for a restoration;
creating a digital model of a die for the restoration, the die including a top portion having a surface formed into a shape of dentition for the dental patient, a bottom portion tapered for insertion into an arch model of the dental arch, and a plurality of slots that extend vertically from a transverse plane within the die to a bottom surface of the bottom portion and radially from a common location within the die to a side wall of the bottom portion; and
fabricating the die from the digital model using a computerized fabrication process.

8. The method of claim 7 wherein the computerized fabrication process includes a stereolithography process.

9. The method of claim 7 wherein the surface is formed into the shape of a tooth of the dental patient prior to preparation for a restoration.

10. The method of claim 7 wherein the surface is formed into the shape of a tooth of the dental patient after preparation for a restoration.

11. The method of claim 7 wherein the surface is formed into the shape desired for a tooth after a restoration.

12. The method of claim 7 wherein each one of the plurality of slots has a bottom opening with beveled edges to increase a capture distance for the plurality of slots by a plurality of support members in an opening of an arch model.

13. The method of claim 7 wherein the plurality of slots includes three slots.

14-21. (canceled)

22. A device comprising:
a model of a dental arch of a dental patient; and
an opening in the model for a die, the opening including an interior wall tapered to receive the die and a plurality of support members extending from the side wall to a common location within the opening.

23. The device of claim 22 further comprising an articulating hinge attached to a back surface of the model.

24. The device of claim 22 further comprising a flat surface on a back of the dental arch for attaching an articulating hinge.

25. The device of claim 22 wherein the model extends from a first back end of the dental arch to a second back end of the dental arch, the device further comprising a first flat surface on the first back end and a second flat surface on a second back end, wherein the first flat surface and the second flat surface are substantially coplanar.

26. The device of claim 22 wherein the model includes an upper arch.

27. The device of claim 22 wherein the model includes a lower arch.

28. The device of claim 22 wherein the plurality of support members includes three support members.

29. The device of claim 22 further comprising a kinematic coupling to provide a bite registration with a second model of an opposing arch.

30. The device of claim 29 wherein the model and the second model, when aligned by the kinematic coupling, provide a pair of coplanar mounting surfaces for attaching an articulating hinge.

31. A method for fabricating a dental model comprising:
receiving a digital surface representation for a dental arch of a dental patient from a three-dimensional scanner;
creating a digital model of the dental arch;
selecting a tooth in the dental arch for a preparation;
creating an opening for the tooth in the digital model, the opening including a side wall tapered to receive a die and a plurality of support members extending from the side wall to a common location within the opening, thereby providing a digital arch model; and
fabricating a physical model from the digital arch model using a computerized fabrication process.

32. The method of claim 31 further comprising aligning the dental arch to an opposing arch according to a bite registration of the dental patient.

33-35. (canceled)

36. The method of claim 35 further comprising adding a kinematic coupling to the digital model to align the digital model to a second digital model of the opposing arch according to the bite registration.

37-43. (canceled)
